(19) United States
(12) Patent Application Publication
(10) Pub. No.: US 2015/0378920 A1
(43) Pub. Date: Dec. 31, 2015

(54) GRAPHICS DATA PRE-FETCHER FOR LAST LEVEL CACHES

(71) Applicants: John G. Gierach, Hillsboro, OR (US); Travis T. Schluessler, Hillsboro, OR (US)

(72) Inventors: John G. Gierach, Hillsboro, OR (US); Travis T. Schluessler, Hillsboro, OR (US)

(21) Appl. No.: 14/320,473

(22) Filed: Jun. 30, 2014

(51) Int. Cl. G06F 12/08; G06T 1/60; G06T 1/20

(52) U.S. Cl. CPC G06F 12/0862; G06T 1/20; G06T 1/60; G06F 2212/1021; G06F 2212/281; G06F 2212/302; G06F 2212/6022

(57) ABSTRACT

In one embodiment, an improved graphics data cache prefetcher includes a cache prefetch unit and a prefetch determination unit (PDU). The PDU determines if there is space available to retrieve some or all of the resources for an upcoming graphics operation while a current graphics operation is processed and whether the retrieval can be performed without impacting the performance of the current operation. If there is space available to retrieve some or all of the upcoming operation's resources into one or more GPU caches the prefetch determination unit programs the cache prefetch unit to retrieve the data into the one or more caches before performing the upcoming operation.

### BACKGROUND

1. Field of the Disclosure

Embodiments are generally related to information processing, and more particularly to a graphics data pre-fetcher for last level caches.

2. Description of the Related Art

When processing hardware executes commands and instructions to perform processing operations, the performance of the processing operations may be bottlenecked by latency caused by the time required to access data in main memory. To improve performance, some data processors may access data that is stored in a cache memory. Generally, data stored in cache memory may be accessed more quickly than data stored in system memory. Additionally, some data processing implementations include multiple levels of cache with each level having a different size and/or access speed.

Graphics processing units (GPUs) commonly accelerate graphics operations through the use of intermediate caches. However, GPU performance bottlenecks may occur during a “cache miss,” which is when accessed data is not present in the cache. During a cache miss, the GPU may be required to traverse successive levels of a multi-level cache hierarchy until the requested data is found. In some instances, data operations may be required to traverse through to the last level of the memory hierarchy before the requested data is retrieved. In some circumstances, the problem lies not in the size of the cache, but the contents of the cache. Data may not be in cache when needed, causing the processor to retrieve the data from the slowest memory.

### BRIEF DESCRIPTION OF THE DRAWINGS

The following description includes discussion of figures having illustrations given by way of example of implementations of the various embodiments. The figures should be understood by way of example, and not by way of limitation, in which:

FIG. 1 is a block diagram of an embodiment of a computer system with a processor having one or more processor cores and graphics processors;

FIG. 2 is a block diagram of one embodiment of a processor having one or more processor cores, an integrated memory controller, and an integrated graphics processor;

FIG. 3 is a block diagram of one embodiment of a graphics processor which may be a discreet graphics processing unit, or may be graphics processor integrated with a plurality of processing cores;

FIG. 4 is a block diagram of an embodiment of a graphics-processing engine for a graphics processor;

FIG. 5 is a block diagram of another embodiment of a graphics processor;

FIG. 6 is a block diagram of thread execution logic including an array of processing elements;

FIG. 7 illustrates a graphics processor execution unit instruction format according to an embodiment;

FIG. 8 is a block diagram of another embodiment of a graphics processor which includes a graphics pipeline, a media pipeline, a display engine, thread execution logic, and a render output pipeline;

FIG. 9A is a block diagram illustrating a graphics processor command format according to an embodiment;

FIG. 9B is a block diagram illustrating a graphics processor command sequence according to an embodiment;

FIG. 10 illustrates exemplary graphics software architecture for a data processing system according to an embodiment;

FIG. 11 shows architecture for one embodiment of computing system including a prefetch determination unit and cache prefetch unit;

FIG. 12 shows an additional architecture for an embodiment of computing system including a prefetch determination unit and cache prefetch unit;

FIG. 13 is a block diagram of a prefetch determination unit and cache prefetch unit, according to an embodiment; and

FIG. 14 is a flow diagram of logic for the prefetch determination unit and cache prefetch unit, according to an embodiment.

### DETAILED DESCRIPTION

In various embodiments, a method, system, and apparatus for increasing GPU cache hit rate through prefetching of data resources is disclosed. The graphics data prefetcher increases the likelihood that a given data access hits at least an intermediate data cache. Increasing the likelihood of a cache hit can increase the performance of memory accesses during graphics operations.

The following description describes processing logic for a graphics data pre-fetcher for last level caches. For the purposes of explanation, numerous specific details are set forth to provide a thorough understanding of the various embodiments described below. However, it will be apparent to a skilled practitioner in the art that the embodiments may be practiced without some of these specific details. In other instances, well-known structures and devices are shown in block diagram form to avoid obscuring the underlying principles, and to provide a more thorough understanding of embodiments.

Although some of the following embodiments are described with reference to a processor, similar techniques and teachings can be applied to other types of circuits or semiconductor devices, as the teachings are applicable to any processor or machine that performs data manipulations.

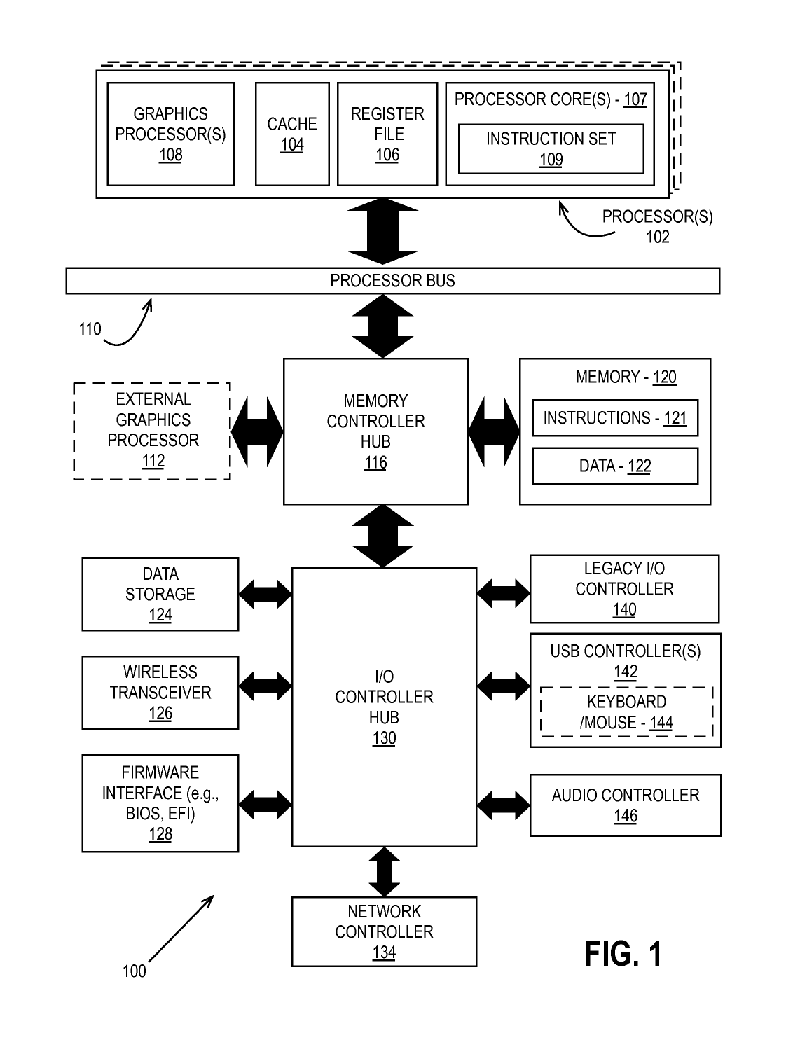

### Overview—FIGS. 1-3

FIG. 1 is a block diagram of a data processing system 100, according to an embodiment. The data processing system 100 includes one or more processors 102 and one or more graphics processors 108, and may be a single processor desktop system, a multiprocessor workstation system, or a server system having a large number of processors 102 or processor cores 107. In on embodiment, the data processing system 100 is a system on a chip integrated circuit (SOC) for use in mobile, handheld, or embedded devices.

An embodiment of the data processing system 100 can include or be incorporated within a server based gaming platform or a game console, including a game and media console, a mobile gaming console, a handheld game console, or an online game console. In one embodiment, the data processing system 100 is a mobile phone, smart phone, tablet computing device or mobile Internet device. The data processing system 100 can also include, couple with, or be integrated within a wearable device, such as a smart watch wearable device, smart eyewear device, augmented reality device, or virtual reality device. In one embodiment, the data processing system 100 is a television or set top box device having one or more processors 102 and a graphical interface generated by one or more graphics processors 108.

The one or more processors 102 each include one or more processor cores 107 to process instructions which, when executed, perform operations for system and user software. In one embodiment, each of the one or more processor cores 107 is configured to process a specific instruction set 109. The instruction set 109 may facilitate complex instruction set computing (CISC), reduced instruction set computing (RISC), or computing via a very long instruction word (VLIW). Multiple processor cores 107 may each process a different instruction set 109 which may include instructions to facilitate the emulation of other instruction sets. A processor core 107 may also include other processing devices, such a digital signal processor (DSP).

In one embodiment, each of the one or more processors 102 includes cache memory 104. Depending on the architecture, the processor 102 can have a single internal cache or multiple levels of internal cache. In one embodiment, the cache memory is shared among various components of the processor 102. In one embodiment, the processor 102 also uses an external cache (e.g., a Level 3 (L3) cache or last level cache (LLC)) (not shown) which may be shared among the processor cores 107 using known cache coherency techniques. A register file 106 is additionally included in the processor 102 which may include different types of registers for storing different types of data (e.g., integer registers, floating point registers, status registers, and an instruction pointer register). Some registers may be general-purpose registers, while other registers may be specific to the design of the processor 102.

The processor 102 is coupled to a processor bus 110 to transmit data signals between the processor 102 and other components in the system 100. The system 100 uses an exemplary ‘hub’ system architecture, including a memory controller hub 116 and an input output (I/O) controller hub 130. The memory controller hub 116 facilitates communication between a memory device and other components of the system 100, while the I/O controller hub (ICH) 130 provides connections to I/O devices via a local I/O bus.

The memory device 120, can be a dynamic random access memory (DRAM) device, a static random access memory (SRAM) device, flash memory device, or some other memory device having suitable performance to serve as process memory. The memory 120 can store data 122 and instructions 121 for use when the processor 102 executes a process. The memory controller hub 116 also couples with an optional external graphics processor 112, which may communicate with the one or more graphics processor 108 in the processor 102 to perform graphics and media operations. The ICH 130 enables peripherals to connect to the memory 120 and processor 102 via a high-speed I/O bus. The I/O peripherals include an audio controller 146, a firmware interface 128, a wireless transceiver 126 (e.g., Wi-Fi, Bluetooth), a data storage device 124 (e.g., hard disk drive, flash memory, etc.), and a legacy I/O controller for coupling legacy (e.g., Personal System 2 (PS/2)) devices to the system. One or more Universal Serial Bus (USB) controllers 142 connect input devices, such as keyboard and mouse 144 combinations. A network controller 134 may also couple to the ICH 130. In one embodiment, a high-performance network controller (not shown) couples to the processor bus 110.

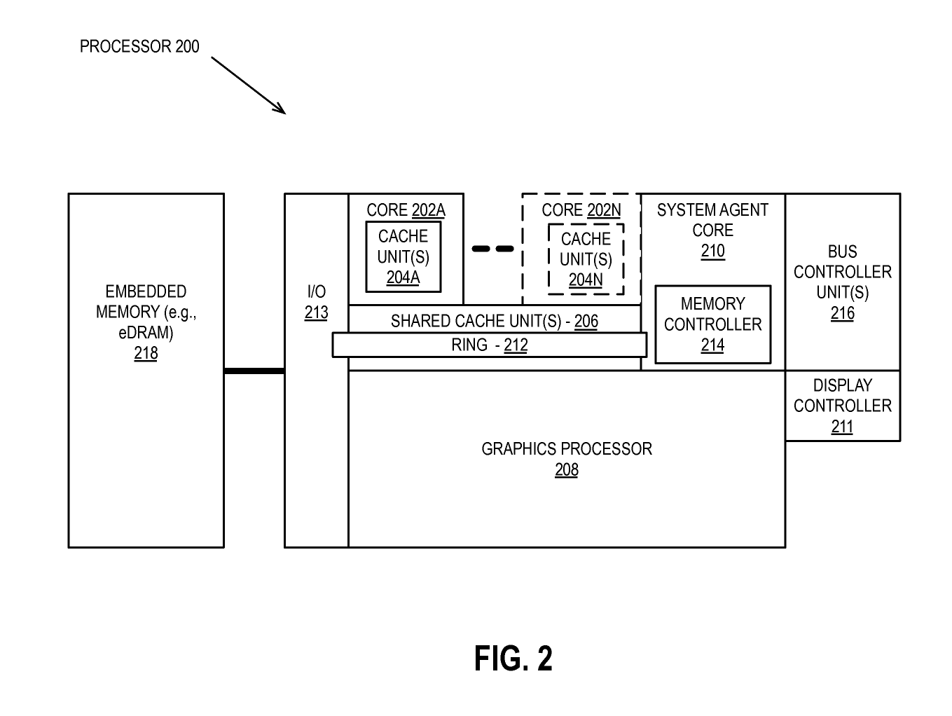

FIG. 2 is a block diagram of an embodiment of a processor 200 having one or more processor cores 202A-N, an integrated memory controller 214, and an integrated graphics processor 208. The processor 200 can include additional cores up to and including additional core 202N represented by the dashed lined boxes. Each of the cores 202A-N includes one or more internal cache units 204A-N. In one embodiment each core also has access to one or more shared cached units 206.

The internal cache units 204A-N and shared cache units 206 represent a cache memory hierarchy within the processor 200. The cache memory hierarchy may include at least one level of instruction and data cache within each core and one or more levels of shared mid-level cache, such as a level 2 (L2), level 3 (L3), level 4 (L4), or other levels of cache, where the highest level of cache before external memory is classified as the last level cache (LLC). In one embodiment, cache coherency logic maintains coherency between the various cache units 206 and 204A-N.

The processor 200 may also include a set of one or more bus controller units 216 and a system agent 210. The one or more bus controller units manage a set of peripheral buses, such as one or more Peripheral Component Interconnect buses (e.g., PCI, PCI Express). The system agent 210 provides management functionality for the various processor components. In one embodiment, the system agent 210 includes one or more integrated memory controllers 214 to manage access to various external memory devices (not shown).

In one embodiment, one or more of the cores 202A-N include support for simultaneous multi-threading. In such embodiment, the system agent 210 includes components for coordinating and operating cores 202A-N during multi-threaded processing. The system agent 210 may additionally include a power control unit (PCU), which includes logic and components to regulate the power state of the cores 202A-N and the graphics processor 208.

The processor 200 additionally includes a graphics processor 208 to execute graphics processing operations. In one embodiment, the graphics processor 208 couples with the set of shared cache units 206, and the system agent unit 210, including the one or more integrated memory controllers 214. In one embodiment, a display controller 211 is coupled with the graphics processor 208 to drive graphics processor output to one or more coupled displays. The display controller 211 may be separate module coupled with the graphics processor via at least one interconnect, or may be integrated within the graphics processor 208 or system agent 210.

In one embodiment a ring based interconnect unit 212 is used to couple the internal components of the processor 200, however an alternative interconnect unit may be used, such as a point to point interconnect, a switched interconnect, or other techniques, including techniques well known in the art. In one embodiment, the graphics processor 208 couples with the ring interconnect 212 via an I/O link 213.

The exemplary I/O link 213 represents at least one of multiple varieties of I/O interconnects, including an on package I/O interconnect which facilitates communication between various processor components and a high-performance embedded memory module 218, such as an eDRAM module. In one embodiment each of the cores 202-N and the graphics processor 208 use the embedded memory modules 218 as shared last level cache.

In one embodiment cores 202A-N are homogenous cores executing the same instruction set architecture. In another embodiment, the cores 202A-N are heterogeneous in terms of instruction set architecture (ISA), where one or more of the cores 202A-N execute a first instruction set, while at least one of the other cores executes a subset of the first instruction set or a different instruction set.

The processor 200 can be a part of or implemented on one or more substrates using any of a number of process technologies, for example, Complementary metal-oxide-semiconductor (CMOS), Bipolar Junction/Complementary metal-oxide-semiconductor (BiCMOS) or N-type metal-oxide-semiconductor logic (NMOS). Additionally, the processor 200 can be implemented on one or more chips or as a system on a chip (SOC) integrated circuit having the illustrated components, in addition to other components.

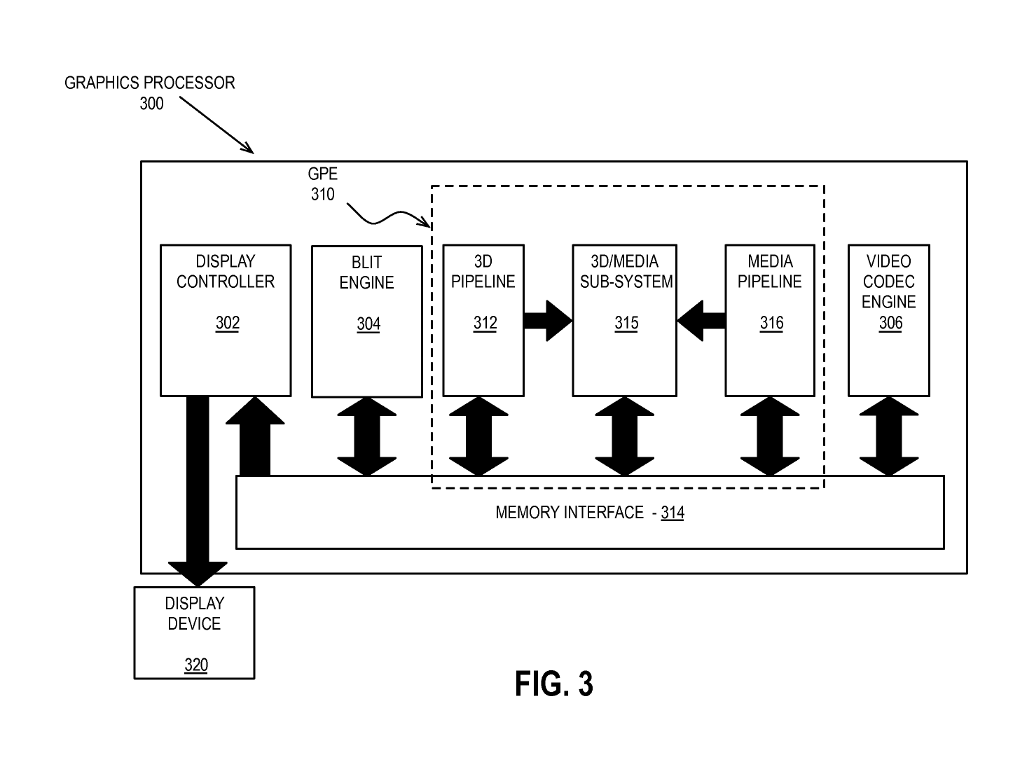

FIG. 3 is a block diagram of one embodiment of a graphics processor 300 which may be a discreet graphics processing unit, or may be graphics processor integrated with a plurality of processing cores. In one embodiment, the graphics processor is communicated with via a memory mapped I/O interface to registers on the graphics processor and via commands placed into the processor memory. The graphics processor 300 includes a memory interface 314 to access memory. The memory interface 314 can be an interface to local memory, one or more internal caches, one or more shared external caches, and/or to system memory.

The graphics processor 300 also includes a display controller 302 to drive display output data to a display device 320. The display controller 302 includes hardware for one or more overlay planes for the display and composition of multiple layers of video or user interface elements. In one embodiment the graphics processor 300 includes a video codec engine 306 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In one embodiment, the graphics processor 300 includes a block image transfer (BLIT) engine 304 to perform two-dimensional (2D) rasterizer operations including, for example, bit-boundary block transfers. However, in one embodiment, 2D graphics operations are performed using one or more components of the graphics-processing engine (GPE) 310. The graphics-processing engine 310 is a compute engine for performing graphics operations, including three-dimensional (3D) graphics operations and media operations.

The GPE 310 includes a 3D pipeline 312 for performing 3D operations, such as rendering three-dimensional images and scenes using processing functions that act upon 3D primitive shapes (e.g., rectangle, triangle, etc.). The 3D pipeline 312 includes programmable and fixed function elements that perform various tasks within the element and/or spawn execution threads to a 3D/Media sub-system 315. While the 3D pipeline 312 can be used to perform media operations, an embodiment of the GPE 310 also includes a media pipeline 316 that is specifically used to perform media operations, such as video post processing and image enhancement.

In one embodiment, the media pipeline 316 includes fixed function or programmable logic units to perform one or more specialized media operations, such as video decode acceleration, video de-interlacing, and video encode acceleration in place of, or on behalf of the video codec engine 306. In on embodiment, the media pipeline 316 additionally includes a thread spawning unit to spawn threads for execution on the 3D/Media sub-system 315. The spawned threads perform computations for the media operations on one or more graphics execution units included in the 3D/Media sub-system.

The 3D/Media subsystem 315 includes logic for executing threads spawned by the 3D pipeline 312 and media pipeline 316. In one embodiment, the pipelines send thread execution requests to the 3D/Media subsystem 315, which includes thread dispatch logic for arbitrating and dispatching the various requests to available thread execution resources. The execution resources include an array of graphics execution units to process the 3D and media threads. In one embodiment, the 3D/Media subsystem 315 includes one or more internal caches for thread instructions and data. In one embodiment, the subsystem also includes shared memory, including registers and addressable memory, to share data between threads and to store output data.

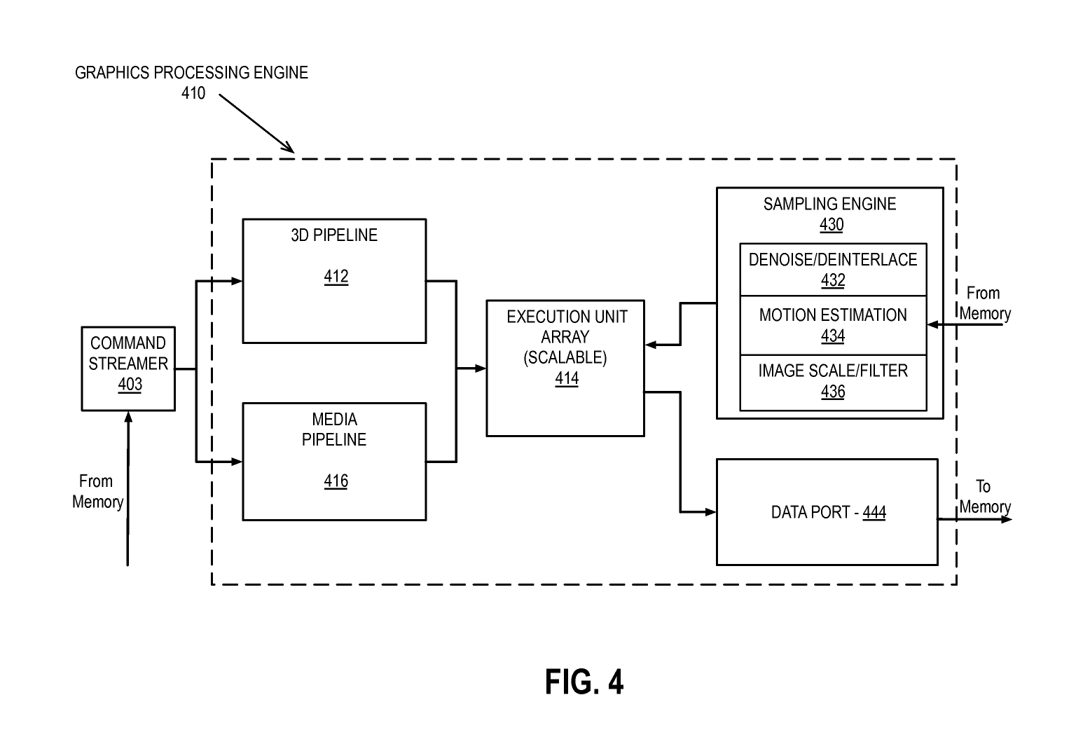

### 3D/Media Processing—FIG. 4

FIG. 4 is a block diagram of an embodiment of a graphics processing engine 410 for a graphics processor. In one embodiment, the graphics processing engine (GPE) 410 is a version of the GPE 310 shown in FIG. 3. The GPE 410 includes a 3D pipeline 412 and a media pipeline 416, each of which can be either different from or similar to the implementations of the 3D pipeline 312 and the media pipeline 316 of FIG. 3.

In one embodiment, the GPE 410 couples with a command streamer 403, which provides a command stream to the GPE 3D and media pipelines 412, 416. The command streamer 403 is coupled to memory, which can be system memory, or one or more of internal cache memory and shared cache memory. The command streamer 403 receives commands from the memory and sends the commands to the 3D pipeline 412 and/or media pipeline 416. The 3D and media pipelines process the commands by performing operations via logic within the respective pipelines or by dispatching one or more execution threads to the execution unit array 414. In one embodiment, the execution unit array 414 is scalable, such that the array includes a variable number of execution units based on the target power and performance level of the GPE 410.

A sampling engine 430 couples with memory (e.g., cache memory or system memory) and the execution unit array 414. In one embodiment, the sampling engine 430 provides a memory access mechanism for the scalable execution unit array 414 that allows the execution array 414 to read graphics and media data from memory. In one embodiment, the sampling engine 430 includes logic to perform specialized image sampling operations for media.

The specialized media sampling logic in the sampling engine 430 includes a de-noise/de-interlace module 432, a motion estimation module 434, and an image scaling and filtering module 436. The de-noise/de-interlace module 432 includes logic to perform one or more of a de-noise or a de-interlace algorithm on decoded video data. The de-interlace logic combines alternating fields of interlaced video content into a single fame of video. The de-noise logic reduces or remove data noise from video and image data. In one embodiment, the de-noise logic and de-interlace logic are motion adaptive and use spatial or temporal filtering based on the amount of motion detected in the video data. In one embodiment, the de-noise/de-interlace module 432 includes dedicated motion detection logic (e.g., within the motion estimation engine 434).

The motion estimation engine 434 provides hardware acceleration for video operations by performing video acceleration functions such as motion vector estimation and prediction on video data. The motion estimation engine determines motion vectors that describe the transformation of image data between successive video frames. In one embodiment, a graphics processor media codec uses the video motion estimation engine 434 to perform operations on video at the macro-block level that may otherwise be computationally intensive to perform using a general-purpose processor. In one embodiment, the motion estimation engine 434 is generally available to graphics processor components to assist with video decode and processing functions that are sensitive or adaptive to the direction or magnitude of the motion within video data.

The image scaling and filtering module 436 performs image-processing operations to enhance the visual quality of generated images and video. In one embodiment, the scaling and filtering module 436 processes image and video data during the sampling operation before providing the data to the execution unit array 414.

In one embodiment, the graphics processing engine 410 includes a data port 444, which provides an additional mechanism for graphics subsystems to access memory. The data port 444 facilitates memory access for operations including render target writes, constant buffer reads, scratch memory space reads/writes, and media surface accesses. In one embodiment, the data port 444 includes cache memory space to cache accesses to memory. The cache memory can be a single data cache or separated into multiple caches for the multiple subsystems that access memory via the data port (e.g., a render buffer cache, a constant buffer cache, etc.). In one embodiment, threads executing on an execution unit in the execution unit array 414 communicate with the data port by exchanging messages via a data distribution interconnect that couples each of the sub-systems of the graphics processing engine 410.

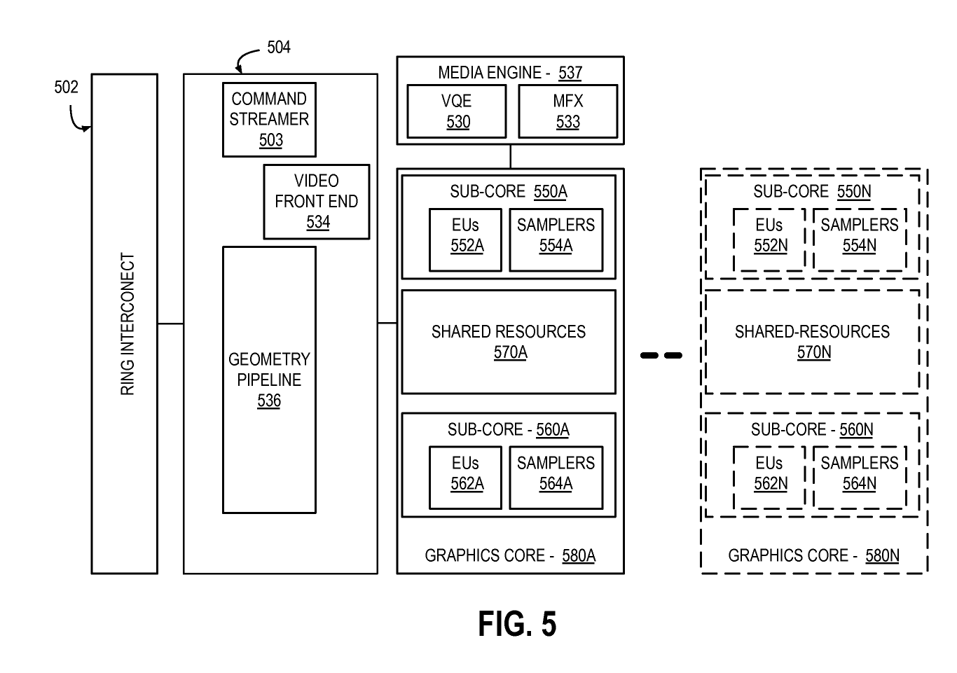

### Execution Units—FIGS. 5-7

FIG. 5 is a block diagram of another embodiment of a graphics processor having a scalable number of graphics cores. In one embodiment, the graphics processor includes a ring interconnect 502, a pipeline front-end 504, a media engine 537, and graphics cores 580A-N. The ring interconnect 502 couples the graphics processor to other processing units, including other graphics processors or one or more general-purpose processor cores. In one embodiment, the graphics processor is one of many processors integrated within a multi-core processing system.

The graphics processor receives batches of commands via the ring interconnect 502. The incoming commands are interpreted by a command streamer 503 in the pipeline front-end 504. The graphics processor includes scalable execution logic to perform 3D geometry processing and media processing via the graphics core(s) 580A-N. For 3D geometry processing commands, the command streamer 503 supplies the commands to the geometry pipeline 536. For at least some media processing commands, the command streamer 503 supplies the commands to a video front end 534, which couples with a media engine 537. The media engine 537 includes a video quality engine (VQE) 530 for video and image post processing and a multi-format encode/decode (MFX) 533 engine to provide hardware-accelerated media data encode and decode. The geometry pipeline 536 and media engine 537 each generate execution threads for the thread execution resources provided by at least one graphics core 580A.

The graphics processor includes scalable thread execution resources featuring modular cores 580A-N (sometime referred to as core slices), each having multiple sub-cores 550A-N, 560A-N (sometimes referred to as core sub-slices). The graphics processor can have any number of graphics cores 580A through 580N. In one embodiment, the graphics processor includes a graphics core 580A having at least a first sub-core 550A and a second core sub-core 560A. In another embodiment, the graphics processor is a low power processor with a single sub-core (e.g., 550A). In one embodiment, the graphics processor includes multiple graphics cores 580A-N, each including a set of first sub-cores 550A-N and a set of second sub-cores 560A-N. Each sub-core in the set of first sub-cores 550A-N includes at least a first set of execution units 552A-N and media/texture samplers 554A-N. Each sub-core in the set of second sub-cores 560A-N includes at least a second set of execution units 562A-N and samplers 564A-N. In one embodiment, each sub-core 550A-N, 560A-N shares a set of shared resources 570A-N. In one embodiment, the shared resources include shared cache memory and pixel operation logic. Other shared resources may also be included in the various embodiments of the graphics processor.

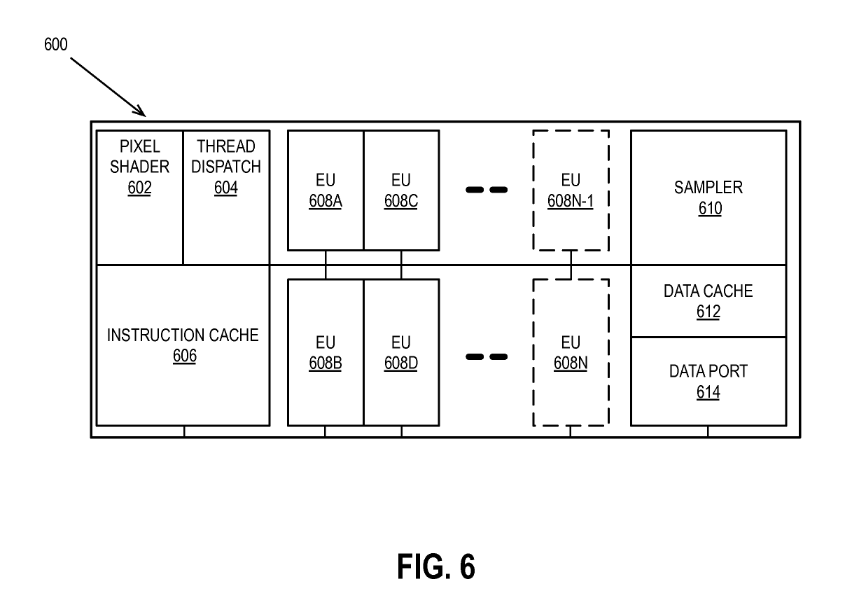

FIG. 6 illustrates an embodiment of thread execution logic 600 including an array of processing elements. In one embodiment, the thread execution logic 600 includes a pixel shader 602, a thread dispatcher 604, instruction cache 606, a scalable execution unit array including a plurality of execution units 608A-N, a sampler 610, a data cache 612, and a data port 614. In one embodiment the included components are interconnected via an interconnect fabric that links to each of the components. The thread execution logic 600 includes one or more connections to memory, such as system memory or cache memory, through one or more of the instruction cache 606, the data port 614, the sampler 610, and the execution unit array 608A-N. In one embodiment, each execution unit (e.g. 608A) is an individual vector processor capable of executing multiple simultaneous threads and processing multiple data elements in parallel for each thread. The execution unit array 608A-N includes any number individual execution units.

In one embodiment, the execution unit array 608A-N is primarily used to execute “shader” programs. In one embodiment, the execution units in the array 608A-N execute an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders).

Each execution unit in the execution unit array 608A-N operates on arrays of data elements. The number of data elements is the “execution size,” or the number of channels for the instruction. An execution channel is a logical unit of execution for data element access, masking, and flow control within instructions. The number of channels may be independent of the number of physical ALUs or FPUs for a particular graphics processor. The execution units 608A-N support integer and floating-point data types.

The execution unit instruction set includes single instruction multiple data (SIMD) instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (quad-word (QW) size data elements), eight separate 32-bit packed data elements (double word (DW) size data elements), sixteen separate 16-bit packed data elements (word (W) size data elements), or thirty-two separate 8-bit data elements (byte (B) size data elements). However, different vector widths and register sizes are possible.

One or more internal instruction caches (e.g., 606) are included in the thread execution logic 600 to cache thread instructions for the execution units. In one embodiment, one or more data caches (e.g., 612) are included to cache thread data during thread execution. A sampler 610 is included to provide texture sampling for 3D operations and media sampling for media operations. In one embodiment, the sampler 610 includes specialized texture or media sampling functionality to process texture or media data during the sampling process before providing the sampled data to an execution unit.

During execution, the graphics and media pipelines send thread initiation requests to the thread execution logic 600 via thread spawning and dispatch logic. The thread execution logic 600 includes a local thread dispatcher 604 that arbitrates thread initiation requests from the graphics and media pipelines and instantiates the requested threads on one or more execution units 608A-N. For example, the geometry pipeline (e.g., 536 of FIG. 5) dispatches vertex processing, tessellation, or geometry processing threads to the thread execution logic 600. The thread dispatcher 604 can also process runtime thread spawning requests from the executing shader programs.

Once a group of geometric objects have been processed and rasterized into pixel data, the pixel shader 602 is invoked to further compute output information and cause results to be written to output surfaces (e.g., color buffers, depth buffers, stencil buffers, etc.). In one embodiment, the pixel shader 602 calculates the values of the various vertex attributes that are to be interpolated across the rasterized object. The pixel shader 602 then executes an API-supplied pixel shader program. To execute the pixel shader program, the pixel shader 602 dispatches threads to an execution unit (e.g., 608A) via the thread dispatcher 604. The pixel shader 602 uses texture sampling logic in the sampler 610 to access texture data in texture maps stored in memory. Arithmetic operations on the texture data and the input geometry data compute pixel color data for each geometric fragment, or discards one or more pixels from further processing.

In one embodiment, the data port 614 provides a memory access mechanism for the thread execution logic 600 output processed data to memory for processing on a graphics processor output pipeline. In one embodiment, the data port 614 includes or couples to one or more cache memories (e.g., data cache 612) to cache data for memory access via the data port.

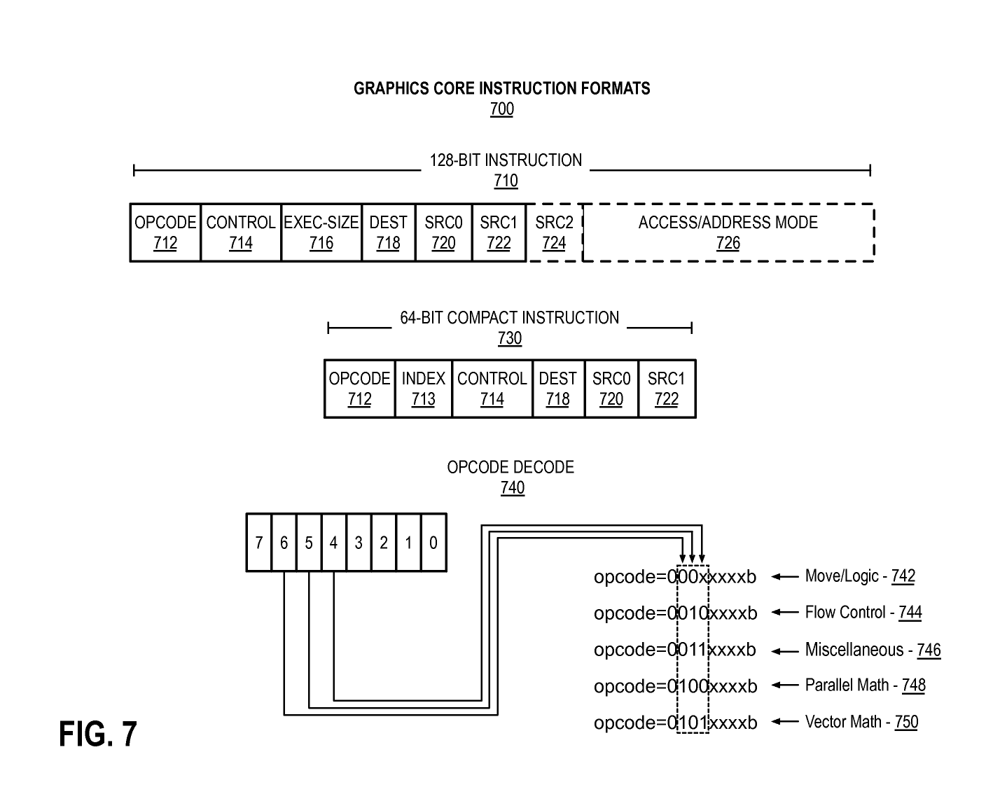

FIG. 7 is a block diagram illustrating a graphics processor execution unit instruction format according to an embodiment. In one embodiment, the graphics processor execution units support an instruction set having instructions in multiple formats. The solid lined boxes illustrate the components that are generally included in an execution unit instruction, while the dashed lines include components that are optional or that are only included in a sub-set of the instructions. The instruction format described an illustrated are macro-instructions, in that they are instructions supplied to the execution unit, as opposed to micro-operations resulting from instruction decode once the instruction is processed.

In one embodiment, the graphics processor execution units natively support instructions in a 128-bit format 710. A 64-bit compacted instruction format 730 is available for some instructions based on the selected instruction, instruction options, and number of operands. The native 128-bit format 710 provides access to all instruction options, while some options and operations are restricted in the 64-bit format 730. The native instructions available in the 64-bit format 730 varies by embodiment. In one embodiment, the instruction is compacted in part using a set of index values in an index field 713. The execution unit hardware references a set of compaction tables based on the index values and uses the compaction table outputs to reconstruct a native instruction in the 128-bit format 710.

For each format, an instruction opcode 712 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. An instruction control field 712 enables control over certain execution options, such as channels selection (e.g., predication) and data channel order (e.g., swizzle). For 128-bit instructions 710 an exec-size field 716 limits the number of data channels that will be executed in parallel. The exec-size field 716 is not available for use in the 64-bit compact instruction format 730.

Some execution unit instructions have up to three operands including two source operands, src0 722, src1 722, and one destination 718. In one embodiment, the execution units support dual destination instructions, where one of the destinations is implied. Data manipulation instructions can have a third source operand (e.g., SRC2 724), where the instruction opcode JJ12 determines the number of source operands. An instruction's last source operand can be an immediate (e.g., hard-coded) value passed with the instruction.

In one embodiment instructions are grouped based on opcode bit-fields to simplify Opcode decode 740. For an 8-bit opcode, bits 4, 5, and 6 allow the execution unit to determine the type of opcode. The precise opcode grouping shown is exemplary. In one embodiment, a move and logic opcode group 742 includes data movement and logic instructions (e.g., mov, cmp). The move and logic group 742 shares the five most significant bits (MSB), where move instructions are in the form of 0000xxxxb (e.g., 0x0x) and logic instructions are in the form of 0001xxxxb (e.g., 0x01). A flow control instruction group 744 (e.g., call, jmp) includes instructions in the form of 0010xxxxb (e.g., 0x20). A miscellaneous instruction group 746 includes a mix of instructions, including synchronization instructions (e.g., wait, send) in the form of 0011xxxxb (e.g., 0x30). A parallel math instruction group 748 includes component-wise arithmetic instructions (e.g., add, mul) in the form of 0100xxxxb (e.g., 0x40). The parallel math group 748 performs the arithmetic operations in parallel across data channels. The vector math group 750 includes arithmetic instructions (e.g., dp4) in the form of 0101xxxxb (e.g., 0x50). The vector math group performs arithmetic such as dot product calculations on vector operands.

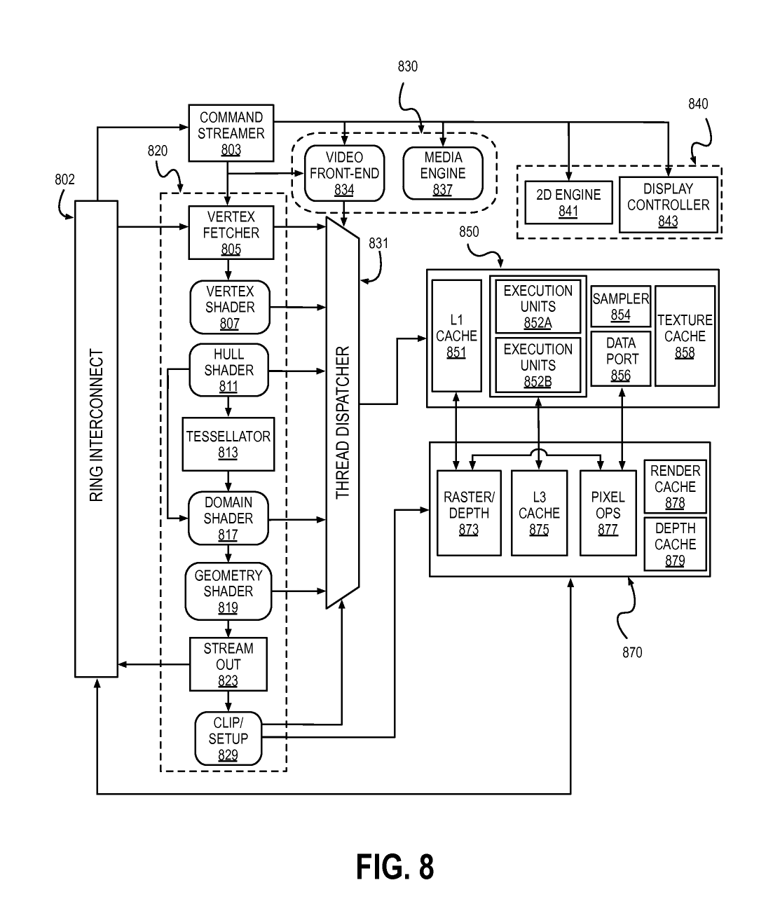

### Graphics Pipeline—FIG. 8

FIG. 8 is a block diagram of another embodiment of a graphics processor which includes a graphics pipeline 820, a media pipeline 830, a display engine 840, thread execution logic 850, and a render output pipeline 870. In one embodiment, the graphics processor is a graphics processor within a multi-core processing system that includes one or more general purpose processing cores. The graphics processor is controlled by register writes to one or more control registers (not shown) or via commands issued to the graphics processor via a ring interconnect 802. The ring interconnect 802 couples the graphics processor to other processing components, such as other graphics processors or general-purpose processors. Commands from the ring interconnect are interpreted by a command streamer 803 which supplies instructions to individual components of the graphics pipeline 820 or media pipeline 830.

The command streamer 803 directs the operation of a vertex fetcher 805 component that reads vertex data from memory and executes vertex-processing commands provided by the command streamer 803. The vertex fetcher 805 provides vertex data to a vertex shader 807, which performs coordinate space transformation and lighting operations to each vertex. The vertex fetcher 805 and vertex shader 807 execute vertex-processing instructions by dispatching execution threads to the execution units 852A, 852B via a thread dispatcher 831.

In one embodiment, the execution units 852A, 852B are an array of vector processors having an instruction set for performing graphics and media operations. The execution units 852A, 852B have an attached L1 cache 851 that is specific for each array or shared between the arrays. The cache can be configured as a data cache, an instruction cache, or a single cache that is partitioned to contain data and instructions in different partitions.

In one embodiment, the graphics pipeline 820 includes tessellation components to perform hardware-accelerated tessellation of 3D objects. A programmable hull shader 811 configures the tessellation operations. A programmable domain shader 817 provides back-end evaluation of tessellation output. A tessellator 813 operates at the direction of the hull shader 811 and contains special purpose logic to generate a set of detailed geometric objects based on a coarse geometric model that is provided as input to the graphics pipeline 820. If tessellation is not used, the tessellation components 811, 813, 817 can be bypassed.

The complete geometric objects can be processed by a geometry shader 819 via one or more threads dispatched to the execution units 852A, 852B, or can proceed directly to the clipper 829. The geometry shader operates on entire geometric objects, rather than vertices or patches of vertices as in previous stages of the graphics pipeline. If the tessellation is disabled the geometry shader 819 receives input from the vertex shader 807. The geometry shader 819 is programmable by a geometry shader program to perform geometry tessellation if the tessellation units are disabled.

Prior to rasterization, vertex data is processed by a clipper 829, which is either a fixed function clipper or a programmable clipper having clipping and geometry shader functions. In one embodiment, a rasterizer 873 in the render output pipeline 870 dispatches pixel shaders to convert the geometric objects into their per pixel representations. In one embodiment, pixel shader logic is included in the thread execution logic 850.

The graphics engine has an interconnect bus, interconnect fabric, or some other interconnect mechanism that allows data and message passing amongst the major components of the graphics engine. In one embodiment the execution units 852A, 852B and associated cache(s) 851, texture and media sampler 854, and texture/sampler cache 858 interconnect via a data port 856 to perform memory access and communicate with render output pipeline components of the graphics engine. In one embodiment, the sampler 854, caches 851, 858 and execution units 852A, 852B each have separate memory access paths.

In one embodiment, the render output pipeline 870 contains a rasterizer and depth test component 873 that converts vertex-based objects into their associated pixel-based representation. In one embodiment, the rasterizer logic includes a windower/masker unit to perform fixed function triangle and line rasterization. An associated render and depth buffer caches 878, 879 are also available in one embodiment. A pixel operations component 877 performs pixel-based operations on the data, though in some instances, pixel operations associated with 2D operations (e.g. bit block image transfers with blending) are performed by the 2D engine 841, or substituted at display time by the display controller 843 using overlay display planes. In one embodiment a shared L3 cache 875 is available to all graphics components, allowing the sharing of data without the use of main system memory.

The graphics processor media pipeline 830 includes a media engine 337 and a video front end 834. In one embodiment, the video front end 834 receives pipeline commands from the command streamer 803. However, in one embodiment the media pipeline 830 includes a separate command streamer. The video front-end 834 processes media commands before sending the command to the media engine 837. In one embodiment, the media engine includes thread spawning functionality to spawn threads for dispatch to the thread execution logic 850 via the thread dispatcher 831.

In one embodiment, the graphics engine includes a display engine 840. In one embodiment, the display engine 840 is external to the graphics processor and couples with the graphics processor via the ring interconnect 802, or some other interconnect bus or fabric. The display engine 840 includes a 2D engine 841 and a display controller 843. The display engine 840 contains special purpose logic capable of operating independently of the 3D pipeline. The display controller 843 couples with a display device (not shown), which may be a system integrated display device, as in a laptop computer, or an external display device attached via an display device connector.

The graphics pipeline 820 and media pipeline 830 are configurable to perform operations based on multiple graphics and media programming interfaces and are not specific to any one application programming interface (API). In one embodiment, driver software for the graphics processor translates API calls that are specific to a particular graphics or media library into commands that can be processed by the graphics processor. In various embodiments, support is provided for the Open Graphics Library (OpenGL) and Open Computing Language (OpenCL) supported by the Khronos Group, the Direct3D library from the Microsoft Corporation, or, in one embodiment, both OpenGL and D3D. Support may also be provided for the Open Source Computer Vision Library (OpenCV). A future API with a compatible 3D pipeline would also be supported if a mapping can be made from the pipeline of the future API to the pipeline of the graphics processor.

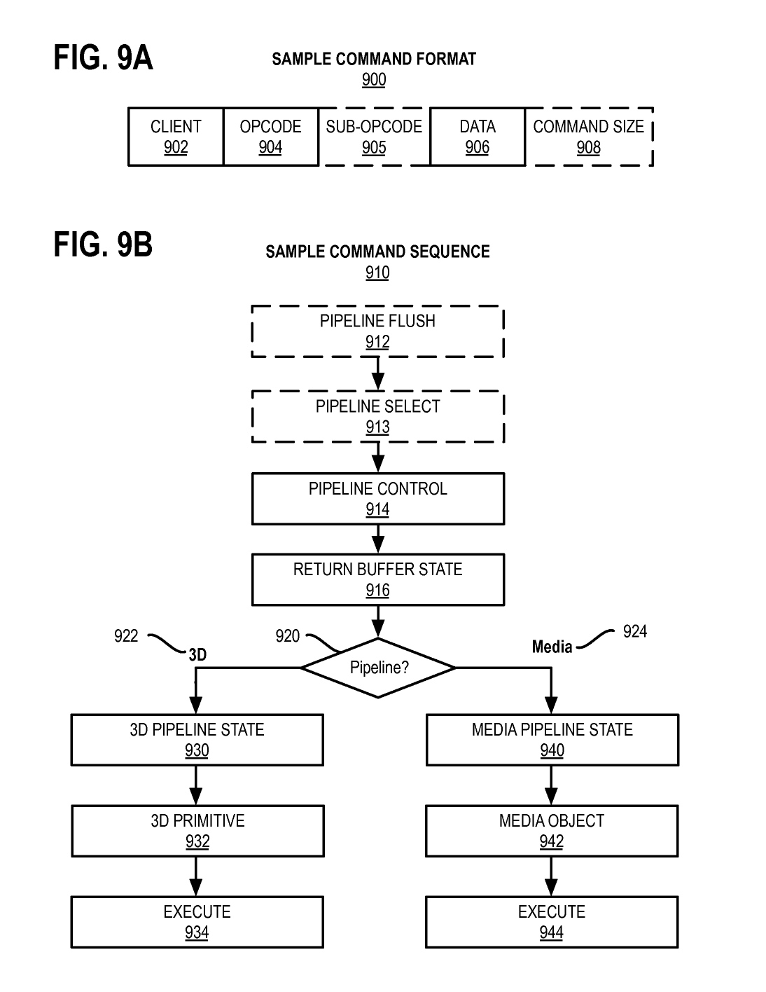

### Graphics Pipeline Programming—FIG. 9A-B

FIG. 9A is a block diagram illustrating a graphics processor command format according to an embodiment and FIG. 9B is a block diagram illustrating a graphics processor command sequence according to an embodiment. The solid lined boxes in FIG. 9A illustrate the components that are generally included in a graphics command while the dashed lines include components that are optional or that are only included in a sub-set of the graphics commands. The exemplary graphics processor command format 900 of FIG. 9A includes data fields to identify a target client 902 of the command, a command operation code (opcode) 904, and the relevant data 906 for the command. A sub-opcode 905 and a command size 908 are also included in some commands.

The client 902 specifies the client unit of the graphics device that processes the command data. In one embodiment, a graphics processor command parser examines the client field of each command to condition the further processing of the command and route the command data to the appropriate client unit. In one embodiment, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 904 and, if present, sub-opcode 905 to determine the operation to perform. The client unit performs the command using information in the data 906 field of the command. For some commands an explicit command size 908 is expected to specify the size of the command. In one embodiment, the command parser automatically determines the size of at least some of the commands based on the command opcode. In one embodiment commands are aligned via multiples of a double word.

The flow chart in FIG. 9B shows a sample command sequence 910. In one embodiment, software or firmware of a data processing system that features an embodiment of the graphics processor uses a version of the command sequence shown to set up, execute, and terminate a set of graphics operations. A sample command sequence is shown and described for exemplary purposes, however embodiments are not limited to these commands or to this command sequence. Moreover, the commands may be issued as batch of commands in a command sequence, such that the graphics processor will process the sequence of commands in an at least partially concurrent manner.

The sample command sequence 910 may begin with a pipeline flush command 912 to cause any active graphics pipeline to complete the currently pending commands for the pipeline. In one embodiment, the 3D pipeline 922 and the media pipeline 924 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. A pipeline flush command 912 can be used for pipeline synchronization or before placing the graphics processor into a low power state.

A pipeline select command 913 is used when a command sequence requires the graphics processor to explicitly switch between pipelines. A pipeline select command 913 is required only once within an execution context before issuing pipeline commands unless the context is to issue commands for both pipelines. In one embodiment, a pipeline flush command is 912 is required immediately before a pipeline switch via the pipeline select command 913.

A pipeline control command 914 configures a graphics pipeline for operation and is used to program the 3D pipeline 922 and the media pipeline 924. The pipeline control command 914 configures the pipeline state for the active pipeline. In one embodiment, the pipeline control command 914 is used for pipeline synchronization and to clear data from one or more cache memories within the active pipeline before processing a batch of commands.

Return buffer state commands 916 are used to configure a set of return buffers for the respective pipelines to write data. Some pipeline operations require the allocation, selection, or configuration of one or more return buffers into which the operations write intermediate data during processing. The graphics processor also uses one or more return buffers to store output data and to perform cross thread communication. The return buffer state 916 includes selecting the size and number of return buffers to use for a set of pipeline operations.

The remaining commands in the command sequence differ based on the active pipeline for operations. Based on a pipeline determination 920, the command sequence is tailored to the 3D pipeline 922 beginning with the 3D pipeline state 930, or the media pipeline 924 beginning at the media pipeline state 940.

The commands for the 3D pipeline state 930 include 3D state setting commands for vertex buffer state, vertex element state, constant color state, depth buffer state, and other state variables that are to be configured before 3D primitive commands are processed. The values of these commands are determined at least in part based the particular 3D API in use. 3D pipeline state 930 commands are also able to selectively disable or bypass certain pipeline elements if those elements will not be used.

The 3D primitive 932 command is used to submit 3D primitives to be processed by the 3D pipeline. Commands and associated parameters that are passed to the graphics processor via the 3D primitive 932 command are forwarded to the vertex fetch function in the graphics pipeline. The vertex fetch function uses the 3D primitive 932 command data to generate vertex data structures. The vertex data structures are stored in one or more return buffers. The 3D primitive 932 command is used to perform vertex operations on 3D primitives via vertex shaders. To process vertex shaders, the 3D pipeline 922 dispatches shader execution threads to graphics processor execution units.

The 3D pipeline 922 is triggered via an execute 934 command or event. In one embodiment a register write triggers command execution. In one embodiment execution is triggered via a ‘go’ or ‘kick’ command in the command sequence. In one embodiment command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

The sample command sequence 910 follows the media pipeline 924 path when performing media operations. In general, the specific use and manner of programming for the media pipeline 924 depends on the media or compute operations to be performed. Specific media decode operations may be offloaded to the media pipeline during media decode. The media pipeline can also be bypassed and media decode can be performed in whole or in part using resources provided by one or more general purpose processing cores. In one embodiment, the media pipeline also includes elements for general-purpose graphics processor unit (GPGPU) operations, where the graphics processor is used to perform SIMD vector operations using computational shader programs that are not explicitly related to the rendering of graphics primitives.

The media pipeline 924 is configured in a similar manner as the 3D pipeline 922. A set of media pipeline state commands 940 are dispatched or placed into in a command queue before the media object commands 942. The media pipeline state commands 940 include data to configure the media pipeline elements that will be used to process the media objects. This includes data to configure the video decode and video encode logic within the media pipeline, such as encode or decode format. The media pipeline state commands 940 also support the use one or more pointers to “indirect” state elements that contain a batch of state settings.

Media object commands 942 supply pointers to media objects for processing by the media pipeline. The media objects include memory buffers containing video data to be processed. In one embodiment, all media pipeline state must be valid before issuing a media object command 942. Once the pipeline state is configured and media object commands 942 are queued, the media pipeline 924 is triggered via an execute 934 command or an equivalent execute event (e.g., register write). Output from the media pipeline 924 may then be post processed by operations provided by the 3D pipeline 922 or the media pipeline 924. In one embodiment, GPGPU operations are configured and executed in a similar manner as media operations.

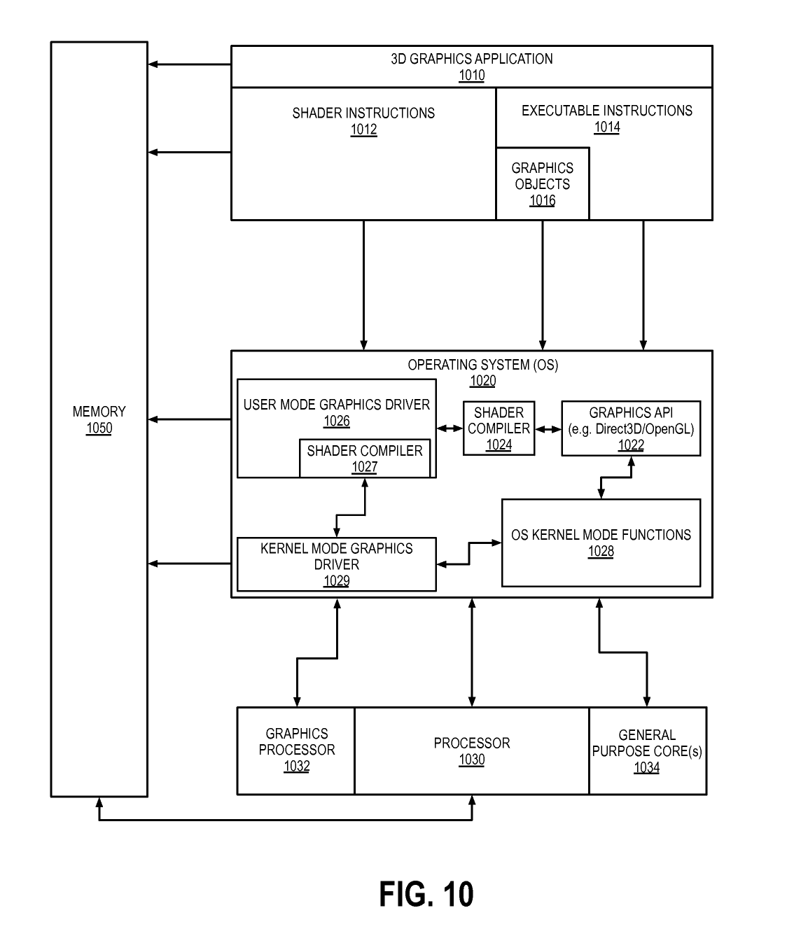

### Graphics Software Architecture—FIG. 10

FIG. 10 illustrates exemplary graphics software architecture for a data processing system according to an embodiment. The software architecture includes a 3D graphics application 1010, an operating system 1020, and at least one processor 1030. The processor 1030 includes a graphics processor 1032 and one or more general-purpose processor core(s) 1034. The graphics application 1010 and operating system 1020 each execute in the system memory 1050 of the data processing system.

In one embodiment, the 3D graphics application 1010 contains one or more shader programs including shader instructions 1012. The shader language instructions may be in a high-level shader language, such as the High Level Shader Language (HLSL) or the OpenGL Shader Language (GLSL). The application also includes executable instructions 1014 in a machine language suitable for execution by the general-purpose processor core 1034. The application also includes graphics objects 1016 defined by vertex data.

The operating system 1020 may be a WINDOWS™ operating system available from the Microsoft Corporation of Redmond, Wash., a proprietary UNIX operating system, or an open source UNIX-like operating system using a variant of the Linux kernel. When the Direct3D API is in use, the operating system 1020 uses a front-end shader compiler 1024 to compile any shader instructions 1012 in HLSL into a lower-level shader language. The compilation may be a just-in-time compilation or the application can perform share pre-compilation. In one embodiment, high-level shaders are compiled into low-level shaders during the compilation of the 3D graphics application 1010.

The user mode graphics driver 1026 may contain a back-end shader compiler 1027 to convert the shader instructions 1012 into a hardware specific representation. When the OpenGL API is in use, shader instructions 1012 in the GLSL high-level language are passed to a user mode graphics driver 1026 for compilation. The user mode graphics driver uses operating system kernel mode functions 1028 to communicate with a kernel mode graphics driver 1029. The kernel mode graphics driver 1029 communicates with the graphics processor 1032 to dispatch commands and instructions.

To the extent various operations or functions are described herein, they can be described or defined as hardware circuitry, software code, instructions, configuration, and/or data. The content can be embodied in hardware logic, or as directly executable software (“object” or “executable” form), source code, high level shader code designed for execution on a graphics engine, or low level assembly language code in an instruction set for a specific processor or graphics core. The software content of the embodiments described herein can be provided via an article of manufacture with the content stored thereon, or via a method of operating a communication interface to send data via the communication interface.

A non-transitory machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface is configured by providing configuration parameters or sending signals to prepare the communication interface to provide a data signal describing the software content. The communication interface can be accessed via one or more commands or signals sent to the communication interface.

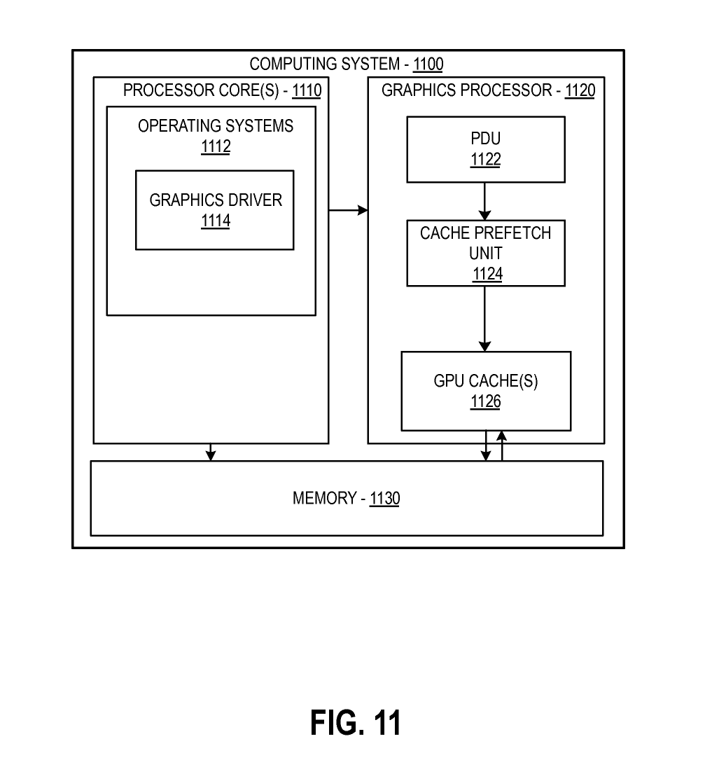

### Graphics Data Prefetcher—FIG. 11-14

In one embodiment, an improved graphics data cache prefetcher includes a cache prefetch unit and a prefetch determination unit (PDU). The PDU determines if there is space available to retrieve some or all of the resources for an upcoming graphics operation while a current graphics operation is processed. The PDU also determines whether the retrieval can be performed without constraining cache availability for the current operation, or otherwise impacting the performance of the current operation. If cache space is available for some or all of the resources of the upcoming graphics operation, the PDU directs the cache prefetch unit to retrieve at least a subset of the identified resources and to store the retrieved resources into a GPU accessible cache before the GPU executes the upcoming operation. In one embodiment, the cache prefetch unit and PDU can reduce or eliminate the latency penalty that would otherwise be incurred by the upcoming operation if the resources for the operation were to be retrieved while the operation is executing.

In one embodiment, when 3D data is rendered by a 3D application (e.g., 3D application 1010 of FIG. 10), the data is configured to propagate from the 3D application through the API to the graphics driver (e.g., user mode graphics driver 1026 of FIG. 10), then through to the graphics processor 1032. Using the data provided through the API, the graphics driver can generate a command buffer containing commands that indicate the set of actions that the hardware is to perform. The command buffer may consist of draw commands and state commands. The state commands may be configured to bind resources that determine how the data is to be rendered on a memory surface, frame buffer or render target. The draw commands cause the GPU to write data to memory. The written data may be re-used for subsequent draw operations or output via a display device.

In one embodiment, the working set for a draw operation includes the set of all resources that are needed to perform a 3D draw operation. Exemplary resources include vertex data and index data to represent the geometry; vertex shaders, geometry shaders, and tessellation shaders to control how vertex data is processed; pixel shaders to determine how the pixels are shaded on the render targets; texture buffers and constant buffers to control variables within the shaders, output vertex data, and to output render targets to which data is rendered. While operations are described with reference to draw calls, the PDU and the cache prefetch and may operate on rendering operations that are of a different scale than a draw call. One embodiment is configured to operate on sets of draws. One embodiment is configured to operate on one or more portions of a single draw.

In one embodiment, the cache prefetch unit and PDU are configurable to fetch data to and from any level within the memory hierarchy. Data may be prefetched to one or more GPU internal caches, to one or more intermediate caches, or to one or more last level caches shared between the GPU and one or more general purpose processor cores. Additionally, data may be prefetched from one level of the memory hierarchy to a lower level of the memory hierarchy.

For example, FIG. 2 shows a graphic processor 208 including one or more shared cache units 206 and an embedded DRAM 218, which may be used as Last Level Caches (LLC) and Extended Last Level caches (eLLC) respectively. In one embodiment the cache prefetch unit and PDU are configured to prefetch data from main memory (e.g., via memory controller 214) into the shared cache units 206 and embedded DRAM 218. In one embodiment, the PDU and cache prefetch unit are configured to prefetch data from one or more of the shared cache units 206 and embedded DRAM 218 into one or more internal caches in the graphics processor 208. Additionally, embodiments are not limited to integrated GPUs and may also be applied to discreet GPUs, such as the external graphics processor 112 shown in FIG. 1.

FIG. 11 shows an exemplary computing system 1100 including one or more processor cores 1110 coupled to a graphics processor 1120, and memory 1130. The computing system 1100 and included components may be incorporated within of any of the data processing systems described herein, such as the data processing system 100 of FIG. 1. The graphics processor 1120 may be an integrated graphics processor or a discreet graphics processor coupled to the one or more processor cores 1110 via a peripheral component interconnect bus (PCI) bus, such as a PCI Express bus. One or more operating systems 1112 (e.g., operating system 1020 of FIG. 10) can be configured to operate using one or more processor cores 1110. A graphics driver 1114 (e.g., user mode graphics driver 1026 or kernel mode graphics driver 1029 of FIG. 10) can be configured to provide a communications interface between the graphics processor 1120 and the operating system 1112.

In one embodiment, the graphics processor 1120 includes a prefetch determination unit (PDU) 1122 coupled to a cache prefetch unit 1124. The cache prefetch unit 1124 is coupled with one or more graphics processor (GPU) caches 1126. The GPU caches 1126 can be configured to cache information (e.g., data, instructions, textures, etc.) from the memory 1130. In one embodiment, the memory 1130 is system memory. In one embodiment, the memory 1130 is a multi-level memory hierarchy shared between the one or more processor cores 1110 and the graphics processor 1120 and includes one or more of an LLC and an eLLC. In one embodiment, the prefetch determination unit 1122 is configured to direct the cache prefetch unit 1124 to cache data for upcoming graphics operations if sufficient cache space is available after caching data for currently executing graphics operations.

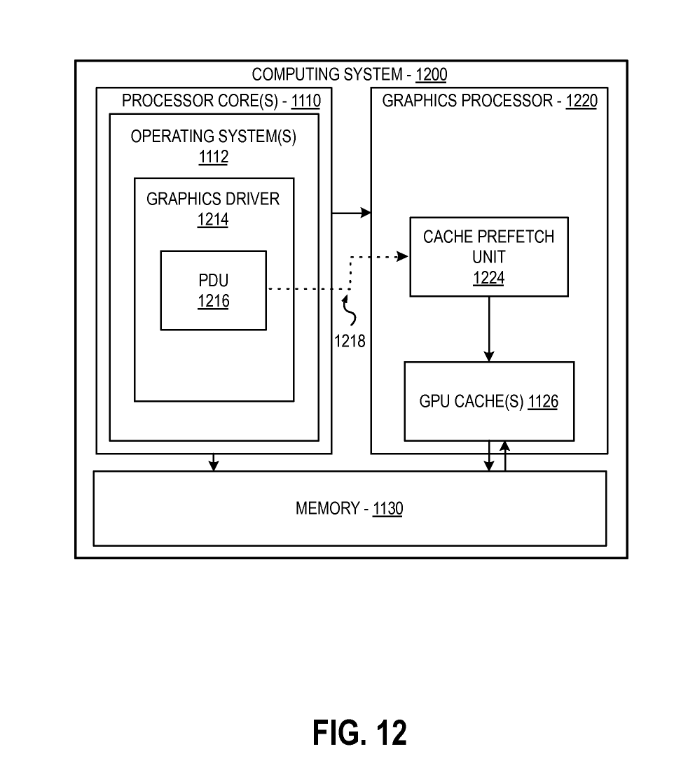

FIG. 12 shows an exemplary computing system 1200 including a graphics processor 1220 with a cache prefetch unit 1224 that is controlled by a PDU 1216 integrated into a graphics driver 1214 for the graphics processor 1220. A control interface 1218 can be configured to enable the driver based prefetch determination unit 1216 to manage the cache prefetch unit 1224 within the graphics processor 1220. In one embodiment, the control interface 1218 is enabled via set of commands directed to the cache prefetch unit 1224. In one embodiment the commands for the control interface 1218 are carried via the general command stream between the graphics driver 1214 and the graphics processor 1220. Alternatively, the control interface 1218 can be an interface directly to the cache prefetch unit 1224 that is specifically provided for the PDU 1216.

The PDU 1216 identifies resources to prefetch into currently unused space in the cache and directs the cache prefetch unit 1224 to retrieve the identified resources. The cache prefetch unit 1224 retrieves the specified resources and stores the resources in one or more GPU caches 1126, or some other cache memory accessible to or shared with the graphics processor 1220. When the next graphics operation begins on the graphics processor 1220 at least some of the resources used by the operation are present in the GPU caches 1126.

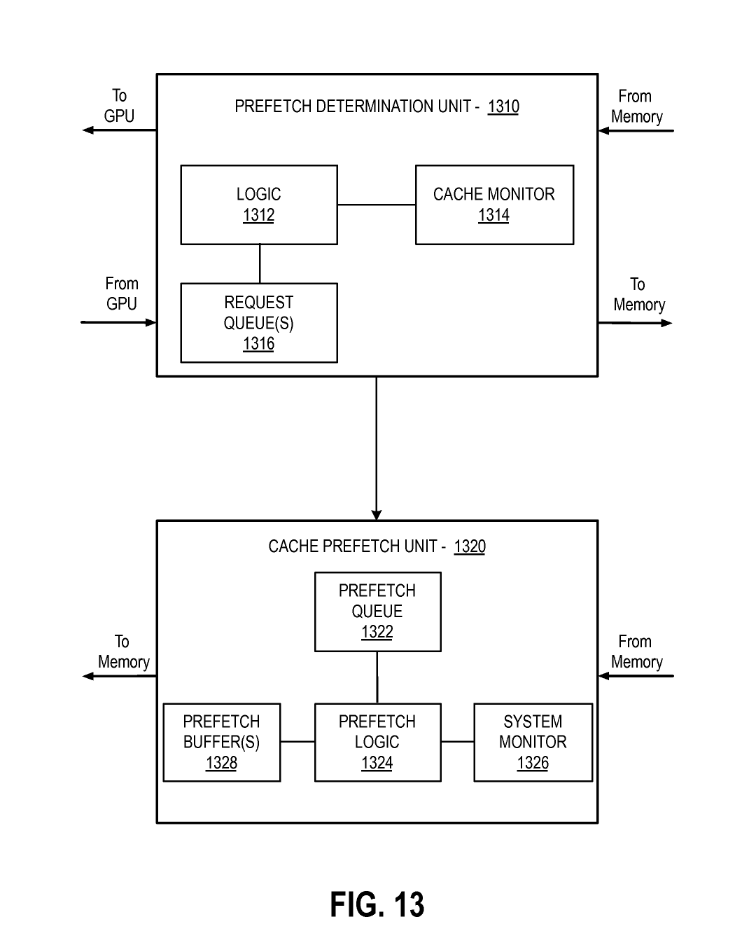

FIG. 13 is a block diagram of a prefetch determination unit 1310 and cache prefetch unit 1320, according to an embodiment. The exemplary prefetch determination unit 1310 includes a logic module 1312, a cache monitor 1314, and one or more request queues 1316. In one embodiment, the prefetch determination unit 1310 is implemented in hardware within the GPU, such as the PDU 1122 of FIG. 11. In one embodiment, the prefetch determination unit 1310 is a hardware module external to the GPU and coupled with the GPU and one or more shared caches. The GPU can track resource usage by graphics operations and the logic module 1312 communicates with the GPU to determine the amount of resources used by a currently executing graphics operation.

In one embodiment, the cache monitor 1314 is configured to track the available cache resources and the logic module 1312 configured to communicate with the cache monitor 1314 to determine the amount of free cache space available in the set of caches that are accessible by the GPU. If cache space is available to prefetch additional resources the logic module 1312 can identify a set of resources for use by the subsequent graphics operation, such as some or all of the working set for an upcoming 3D draw operation. The logic module 1312 can then place a set of prefetch requests in the one or more request queues 1316. Request in the request queue can identify a set of resources to prefetch and identify a specific cache memory to place the resources. The prefetch requests can be dispatched from the request queues 1316 to one or more cache prefetch units across various levels of a multi-level memory hierarchy based on the target cache for the request.

In one embodiment one or more components of the prefetch determination unit 1310 are implemented in driver logic for the GPU, such as in the PDU 1216 in the graphics driver 1214 of FIG. 12. In such embodiment, the logic 1312 module for the PDU utilizes the graphics driver's awareness of the resources bound by the individual graphics operations. The driver implemented logic module 1312 uses the resource information to identify resources used for upcoming draw calls and directs the cache prefetch unit 1320 to prefetch those resources. The driver is aware of the working set of resources that are in use for each draw operation, so the prefetching can be limited to cache space left available after accounting for the resources used by the currently executing operations. In one embodiment, the logic module 1312 calculates the cache usage of the maximum possible size of the working set of a current draw operation to determine the amount of cache space that can be safely used for resources for an upcoming, but not yet executing draw operation. The logic module 1312 can then direct the cache prefetch unit 1320 to prefetch resources up to the calculated limit of the available space in cache.

In some circumstances, not all of the resources bound to a graphics operation are used during the operation. In one embodiment, an API extension is provided to enable an application to identify the specific set of resources that will be used by a draw operation, such as whether a draw will use the entire working set of resources or only a subset of the resources. In one embodiment, the GPU hardware is configured to provide information regarding the precise subset of resources actually used for each executing operation at runtime, enabling additional data to be fetched for subsequent operations.

The cache prefetch unit 1320 receives and processes the prefetch requests dispatched from the prefetch determination unit 1310. Each cache level in the memory hierarchy can have a cache prefetch unit 1320. The exemplary cache prefetch unit 1320 includes a prefetch queue 1322, prefetch logic 1324, a system monitor 1326 and a set of one or more prefetch buffers 1328. The prefetch queue 1322 can store incoming prefetch requests from the prefetch determination unit 1310. The prefetch logic can perform the incoming requests in conjunction with performing other prefetching operations, such as runtime instruction and data prefetching for currently executing operations. In one embodiment, the system monitor 1326 informs the prefetch logic 1324 of various data elements relevant to general cache prefetch operations, such as ongoing memory access requests, recent cache misses, current memory bus activity, current memory latency, etc., to enable the cache prefetch unit 1320 to perform general prefetch operations. When storing prefetched data, the prefetch buffers 1328 may be used to buffer outgoing writes to a target cache memory as directed by the prefetch determination unit 1310. At least one of the prefetch buffers 1328 may also be used as a stream buffer, or otherwise used for general prefetch operations.

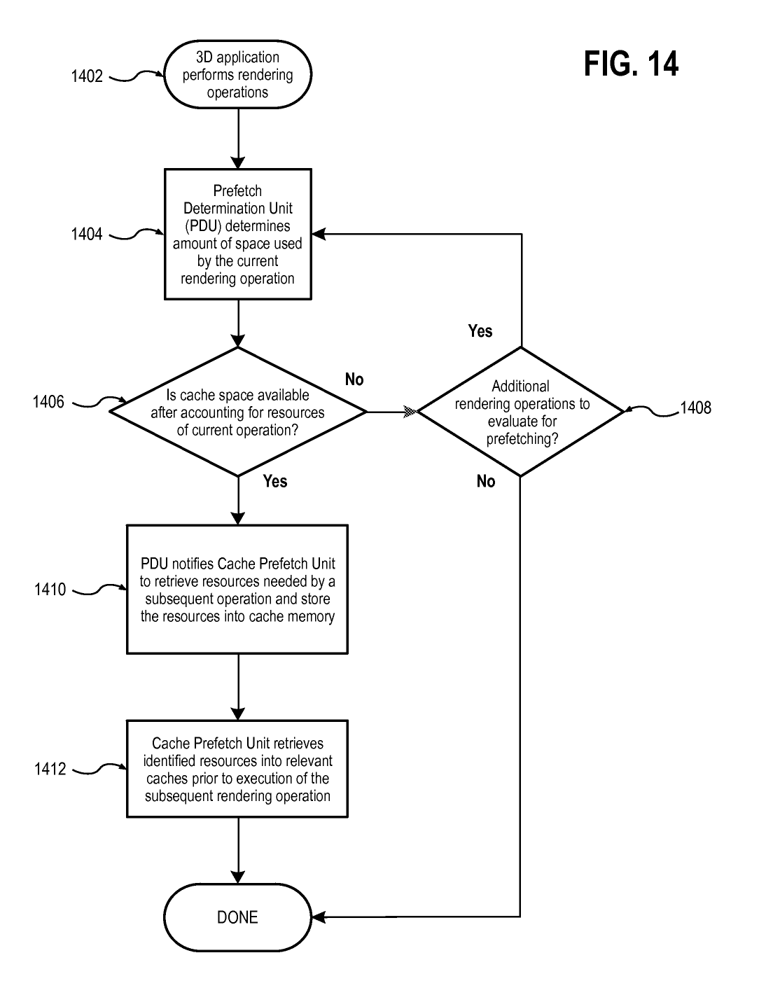

FIG. 14 is a flow diagram of logic for the prefetch determination unit and cache prefetch unit, according to an embodiment. In one embodiment, a 3D application performs graphics operations, such as graphics rendering operations, as shown at block 1402. The prefetch determination unit (PDU) determines the amount of space used by the current rendering operation, as shown at block 1404. At block 1406, the PDU determines if cache space is available after accounting for the resources used by the currently executing operation. If there is not sufficient cache space available, the PDU control logic determines if there are any other rendering operations to evaluate for prefetching, as shown at block 1408. If there are additional operations to evaluate, the PDU logic returns to block 1404 to evaluate the next available rendering operation. If no additional operations are available for evaluation, the PDU operations are complete until a new set of graphics operations are received.

At block 1406, the PDU may determine that cache space is available in the set available caches using one of several methods. In one embodiment, the PDU is configured to calculate the maximum possible working set size of the currently rendering operation. The maximum possible working set size represents the maximum amount of cache space that may be used by the currently rendering operation. In one embodiment, the PDU is precisely informed of the resources to be used by the 3D application via a provided API or API extension. In one embodiment, the GPU is aware of the subset of the working set that is used by each command and communicates that information to the PDU. In one embodiment, the PDU can detect post-processing workloads, where one or more prior render targets are used to generate a subsequent render target. In such configuration, the PDU may automatically determine the working set for the subsequent command. For example, a post processing draw command may be issued using a quad primitive, and the PDU can use the bounding box of the quad to determine the resources to prefetch. In one embodiment, the PDU can detect texture data to fetch based on referencing texture coordinates within each vertex of a quad primitive used by a draw command.

The PDU may then, as shown at block 1410, notify the cache prefetch unit to retrieve resources needed by a subsequent operation and store the resources for the subsequent operation into cache memory. Accordingly, at block 1412, the cache prefetch unit may retrieve the identified resources into the relevant caches prior to execution of the subsequent rendering operation. The relevant caches may be any one or more of an internal cache of the graphics processor, a shared cache, an LLC, or an eLLC, according to an embodiment.

The use of an embodiment of the graphics data prefetcher described herein can enable consistent performance from graphics operations across a graphics workload by reducing cache misses and reducing operational latency caused by loading data for graphics operations into cache memory. In one embodiment, graphics operations can achieve performance metrics on a first execution similar to the performance metrics the operation can achieve on subsequent, repeated operations when the resources are fully resident in cache.

In one embodiment, the graphics data prefetcher includes an apparatus comprising a cache, a cache prefetch unit, and a prefetch determination unit. In one embodiment, the cache prefetch unit is to retrieve resources identified for use by a second rendering operation and to store the identified resources in the cache. In one embodiment, the prefetch determination unit is to determine an amount of cache available during a first graphics operation, to identify a set of resources for use by the second graphics operation, and to notify the cache prefetch unit to retrieve at least a subset of the identified resources during the first graphics operation.

In one embodiment, a system comprises memory, a display coupled to the memory, a processing unit coupled to the memory, and apparatus coupled to the processing unit, where the apparatus comprises a graphics processing unit, a cache, and a cache prefetch unit. The system additionally comprises a prefetch determination unit to determine an amount of cache space used by a first rendering operation and when the amount of space is less than available cache space, to notify the cache prefetch unit of the apparatus to retrieve a resource for use by a second rendering operation. In one embodiment, the driver module for the GPU includes the logic for the PDU. In one embodiment, an application programming interface is used to provide information about resources used by graphics operations to the driver module. The PDU is to program the cache prefetch unit based on the provided information. In one embodiment, the memory includes a render target of the first rendering operation or the second rendering operation, and where the render target is output to the display.

In one embodiment, a machine-readable medium stores instructions which, if performed by one or more processors, causes the one or more processors to perform operations comprising determining an amount of cache space used by a first graphics operation while the first graphics operation is executing and determining if cache space is available after determining the amount of cache space used by the first graphics operation. When cache space is available, the operations additionally comprise identifying a set of resources for use by a second graphics operation, causing a cache prefetch unit to retrieve a set of resources including at least a subset of the identified resources, and causing the cache prefetch unit to store the set of resources into the cache for use by the second graphics operation before the second operation is executed. In one embodiment, the resources include a working set for a draw operation. In one embodiment, the cache described herein can couple with memory. The memory can be a component of a multi-level cache memory, which can be shared with one or more processor cores, and can be a last level cache or an extended last level cache.

As used herein, references to one or more “embodiments” are to be understood as describing a particular feature, structure, or characteristic included in at least one implementation. Thus, phrases such as “in one embodiment” or “in an alternate embodiment” appearing herein, each describe various embodiments and implementation, and do not necessarily all refer to the same embodiment. However, they are also not necessarily mutually exclusive.

The terms “first,” “second,” “third,” “fourth,” and the like in the description and in the claims are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

Various components can be a means for performing the operations or functions described. Each component described herein includes software, hardware, or a combination of these. The components can be implemented as software modules, hardware modules, special-purpose hardware (e.g., application specific hardware, application specific integrated circuits (ASICs), DSPs, etc.), embedded controllers, hardwired circuitry, etc. Besides what is described herein, various modifications can be made to the disclosed embodiments and implementations without departing from their scope. Therefore, the illustrations and examples herein should be construed in an illustrative, and not a restrictive sense. The scope and spirit of the invention should be measured solely by reference to the claims that follow.

What is claimed is:

1. An apparatus comprising:
a cache;
a prefetch determination unit (PDU) to determine an amount of cache available during a first graphics operation and identify resources stored in memory for use by a second graphics operation;
a cache prefetch unit to retrieve the identified resources from the memory and store the identified resources in the cache, wherein the cache prefetch unit to receive a notification from the PDU to retrieve the identified resources during the first graphics operation.

2. The apparatus of claim 1, wherein the memory is a multi-level cache memory.

3. The apparatus of claim 1, wherein the memory is shared at least between the cache prefetch unit and a processor core.

4. The apparatus of claim 1, further comprising a plurality of graphics cores to execute the first and second graphics operations, wherein the plurality of graphics cores couple to the cache.

5. The apparatus of claim 4, wherein the apparatus is a graphics processing unit (GPU).

6. The apparatus of claim 4, wherein the cache is shared between the one or more graphics cores.

7. The apparatus of claim 4, wherein the cache is a last level cache of a multi-level cache hierarchy.

8. The apparatus of claim 1, wherein the PDU to calculate a maximum working set size of the first graphics operation while the first graphics operation is a current graphics operation and subtract the maximum working set size from a size of the cache to determine the amount of cache available during the first graphics operation.

9. The apparatus of claim 8, wherein the PDU to notify the cache prefetch unit to store the retrieved resources into the cache.

10. A system comprising:
a memory;
a display coupled to the memory;
a processing unit coupled to the memory;
a graphics processing unit (GPU) coupled to the processing unit, the GPU including a cache and a cache prefetch unit; and
a prefetch determination unit (PDU) to determine an amount of cache available during a first graphics operation, identify resources stored in memory for use by a second graphics operation and notify the cache prefetch unit to retrieve the identified resources during the first graphics operation.

11. The system of claim 10, wherein the memory is shared at least between the processing unit and the GPU.

12. The system of claim 10, wherein the memory is a multi-level cache memory.

13. The system of claim 10, wherein the memory is embedded memory.

14. The system of claim 10, wherein the second graphics operation to render to a render target and the render target is output to the display.

15. The system of claim 10, wherein the PDU is a component of a software driver for the GPU.

16. A machine-readable medium having stored thereon instructions, which if performed by one or more processors, causes the one or more processors to perform operations comprising:
determining an amount of cache used by a first graphics operation while the first graphics operation is executing;
determining if cache is available after determining the amount of cache used by the first graphics operation;
identifying resources for use by a second graphics operation;
retrieving the resources from memory during the first graphics operation; and
storing the resources in the cache before the second graphics operation is executed.

17. The medium as in claim 16, wherein the cache is a multi-level cache.

18. The medium as in claim 16, wherein determining the amount of cache used by the first graphics operation comprises calculating a maximum working set size of the first graphics operation and determining if cache is available comprises subtracting the maximum working set size from the size of the cache.

19. The medium as in claim 16, wherein the set of resources include a draw operation working set.

20. The medium as in claim 16, further comprising instructions to perform operations including evaluating additional graphics operations for prefetching.
